(19) United States
(12) Patent Application Publication
(10) Pub. No.: US 2008/0166077 A1
(43) Pub. Date: Jul. 10, 2008

(54) Self-lubrication alignment bearing

(76) Inventor: Ping-Hsien Chou, Tainan (TW)

Correspondence Address: Hershkovitz & Associates, LLC, 2845 Duke Street, Alexandria, VA, 22314, US

(21) Appl. No.: 11/649,861

(22) Filed: Jan. 5, 2007

(51) Int. Cl. F16C 33/10

(52) U.S. Cl. 384/291

(57) ABSTRACT

An self-lubrication alignment bearing includes a sleeve having therein a top recess defined in a top portion thereof, a bottom recess defined in a bottom portion thereof to communicate with the top recess via a longitudinally defined channel in which the shaft is rotatably received, a bottom cap received in the bottom recess and a returning passage defined inside the sleeve to communicate the bottom recess with the top recess.

### BACKGROUND OF THE INVENTION

1. Field of the Invention

The present invention relates to a self-lubrication alignment bearing, and more particularly to an alignment bearing having therein a returning passage communicating the first conical recess defined in a top of the sleeve with the second conical recess defined in a bottom of the sleeve such that lubricant is able to circle around inside the lubricating sleeve.

2. Description of the Prior Art

A currently available alignment bearing normally is applicable in a fan assembly having a shaft extending into the alignment bearing such that the fan blades of the fan assembly are able to rotate.

When in operation, the rotation of the fan shaft inside the alignment bearing generates heat, which brings out the lubricant inside the alignment bearing to lubricate the rotational movement of the fan shaft. However, the rotational movement of the fan shaft somewhat spins out the lubricant and causes bad lubrication effect. Thus the life span of the alignment bearing is affected.

Further, the alignment bearing generally is composed of a sleeve and lubricant received inside the sleeve. When this type of alignment bearing is used with a fan assembly, air inside the sleeve may cause difficulty especially when the fan shaft is extended into the sleeve. Still further, since the lubricant is easily spun out to the bottom of the sleeve, it is quite difficult to allow the lubricant to flow back to the top of the sleeve. Consequently, the lubrication effect to the fan shaft is greatly affected.

To overcome the shortcomings, the present invention tends to provide an improved self-lubrication alignment bearing to mitigate the aforementioned problems.

### SUMMARY OF THE INVENTION

The primary objective of the present invention is to provide a self-lubrication alignment bearing to allow the lubricant to returning passage defined inside sleeve to communication the first conical recess at the top of the sleeve and the second conical recess at the bottom of the sleeve such that lubricant at the bottom of the sleeve easily flows back to the top of the sleeve to continue provide lubrication effect.

Another objective of the present invention is that an annular recess is defined in a side face of a channel defined through the sleeve to refrain the lubricant from being spun out of the sleeve.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the alignment bearing of the present invention;

FIG. 2 is a schematic cross sectional view showing the combination of the alignment bearing of the present invention; and

FIG. 3 is a schematic cross sectional view showing that a fan shaft is extended into the channel of the alignment bearing of the present invention.

### DETAILED DESCRIPTION OF THE PREFERRED EMBODIMENT

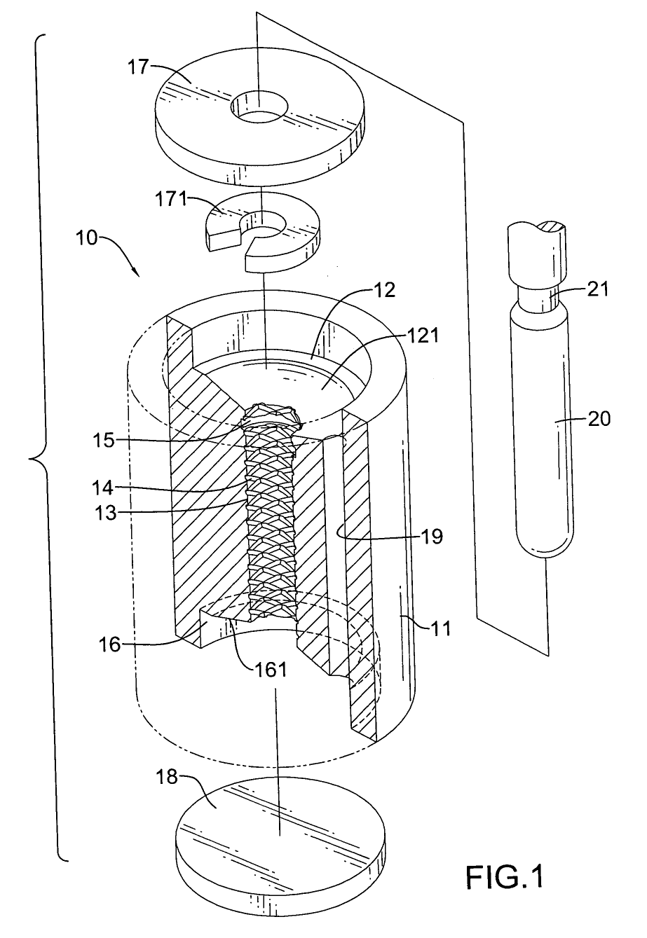

With reference to FIG. 1, it is noted that the alignment bearing in accordance with the present invention include a sleeve (11) having a top recess (12) defined in a top portion of the sleeve (11), a channel (13) defined through the sleeve (11), multiple crossed grooves (140 defined in an inner periphery defining the channel (13) and a bottom recess (16) defined in a bottom portion of the sleeve (11) to communicate with the top recess (12) via the channel (13). In addition, a first conical recess (121) is defined to be in communication with the top recess (12) and the channel (13) and a second conical recess (161) is defined to be in communication with the bottom recess (16) and the channel (13). A returning passage (19) is longitudinally defined inside the sleeve (11) to communicate the top recess (12) with the bottom recess (16) and an annular recess (15) is defined in the inner periphery of the channel (13).

A bottom cap (18) is provided to be received in the bottom recess (16) and a top cap (17) is provided to be received in the top recess (12). Further, a C shaped ring (171) is to be received in the annular recess (15).

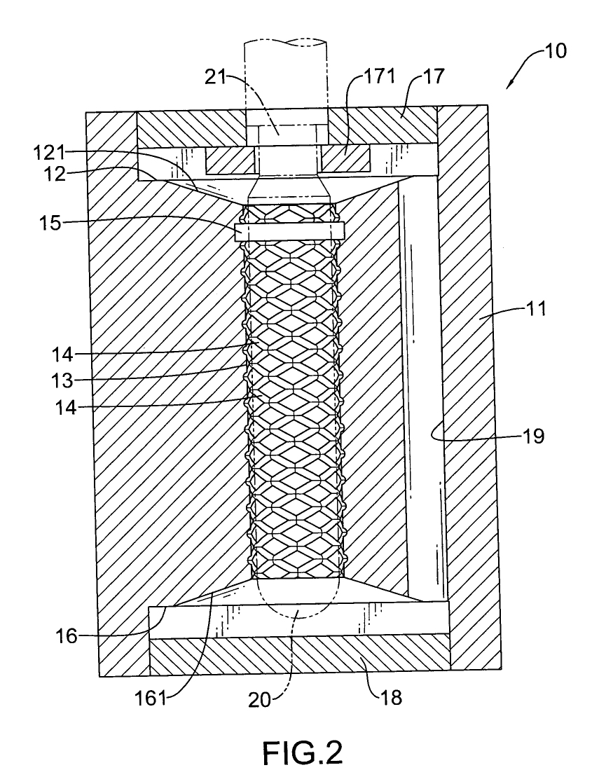

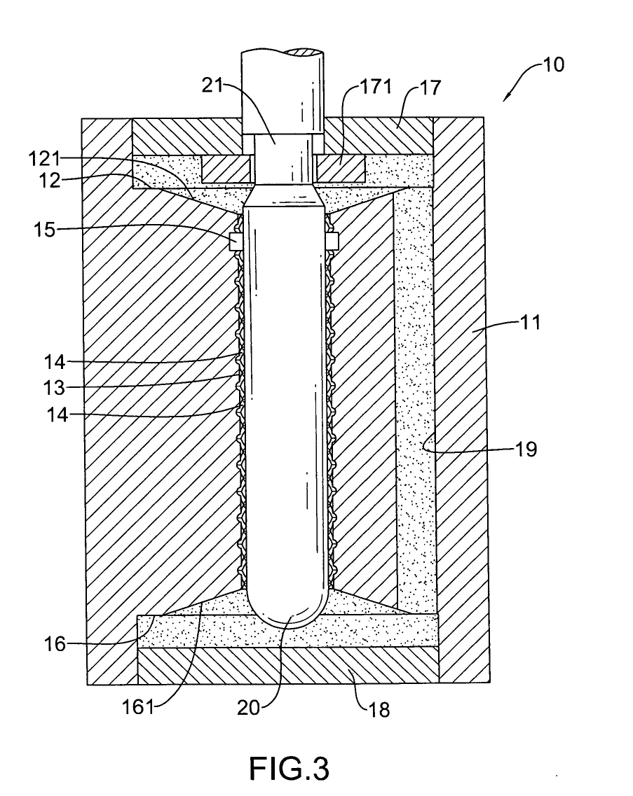

With reference to FIGS. 2 and 3, after the assembly of the alignment bearing of the present invention is finished, it is noted that the bottom cap (18) is received in the bottom recess (16) and before the top cap (17) is received in the top recess (12), a shaft (20) with a neck (21) is extended into the channel (13) with the C shaped ring (171) clamping in the neck (21).

From the depiction of the accompanying drawings, it is noted that with the provision of the returning passage (19), when the shaft (20) is extended into the channel (13), the air already received inside the channel (13) will be forced to flow to the second conical recess (161), the bottom recess (16), the returning passage (19), the first conical recess (121) and the top recess (12). Eventually the air escapes the sleeve (11) such that the shaft (20) is refrained from floating in the air inside the channel (13).

Before operation, the lubricant is able to flow downward from the first conical recess (121) and into the channel (13). Due to the formation of the crossed grooves (14) in the inner periphery of the channel (13), the downward flowing lubricant forms a lubrication screen to provide a perfect lubrication effect between the outer periphery of the shaft (20) and the inner periphery of the channel (13). When in operation, the rotation of the shaft (20) inside the sleeve (11) forces the lubricant to flow upward from the bottom recess (16) via the returning passage (19) to the first conical recess (121). Again, the lubricant in the first conical recess (121) is able to flow downward to the bottom recess (16) via the channel (13). Therefore, the lubricant is flowing up and down over and over again to provide the lubrication effect to the shaft (20) and the sleeve (11) as long as the shaft (20) is pining. Still further, due to the provision of the annular recess (15), should the lubricant flow upward inside the channel (13), the annular recess (15) functions as a buffer to stop the upward flowing lubricant from overflowing to the top recess (12).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An self-lubrication alignment bearing for a shaft, the self-lubrication alignment bearing consisting of:
a sleeve having therein a top recess defined in a top portion thereof, a bottom recess defined in a bottom portion thereof to communicate with the top recess via a longitudinally defined channel in which the shaft is rotatably received, a bottom cap received in the bottom recess and a returning passage defined inside the sleeve to communicate the bottom recess with the top recess.

2. The self-lubricating alignment bearing as claimed in claim 1 further comprising a first conical recess defined in the sleeve to communicate the channel with the top recess and a second conical recess defined in the sleeve to communicate the channel with the bottom recess so that lubricant is able to flow downward from the first conical recess to the bottom recess via the channel and then flow upward from the bottom recess to the first conical recess via the returning passage to provide lubrication effect to the shaft and the sleeve.

3. The self-lubricating alignment bearing as claimed in claim 1 further comprising crossed grooves defined in an inner periphery of the channel and an annular recess defined in the inner periphery of the channel for receiving therein lubricant so as to stop upward flowing lubricant from overflowing to the first conical recess.

4. The self-lubricating alignment bearing as claimed in claim 2 further comprising crossed grooves defined in an inner periphery of the channel and an annular recess defined in the inner periphery of the channel for receiving therein lubricant so as to stop upward flowing lubricant from overflowing to the first conical recess.
